(19) United States
(12) Patent Application Publication
(10) Pub. No.: US 2009/0249437 A1
(43) Pub. Date: Oct. 1, 2009

(54) ASSIGNMENT OF POLICY FUNCTION ADDRESS DURING ACCESS AUTHENTICATION IN WIMAX NETWORKS

(76) Inventor: Domagoj Premec, Zagreb (HR)

Correspondence Address: STAAS & HALSEY LLP, SUITE 700, 1201 NEW YORK AVENUE, N.W., WASHINGTON, DC, 20005, US

(21) Appl. No.: 12/226,517

(22) PCT Filed: Apr. 18, 2007
(86) PCT No.: PCT/EP2007/053787

§ 371 Date: Oct. 21, 2008

(30) Foreign Application Priority Data
Apr. 21, 2006 (EP) 06008318.5

(51) Int. Cl. G06F 21/00; G06F 21/20

(52) U.S. Cl. 726/1; 726/4

(57) ABSTRACT

A policy function used by a Service Flow Authorization of an Internal Protocol network is dynamically specified. A mobile station sends a request to a Network Access Servicer. Service Equipment forwards the request to a Service Provider's AAA Server. A connectively serving network sends an Access-Accept RADIUS message to an accessing serving network. The PF address is inserted into the Access-Accept RADIUS message.

### CROSS REFERENCE TO RELATED APPLICATIONS

This application is based on and hereby claims priority to PCT/EP/2007/053787 filed on Apr. 18, 2007 and European Application Number EP06008318 filed on Apr. 21, 2006, the contents of which are hereby incorporated by reference.

### BACKGROUND OF THE INVENTION

The invention relates to IP networks and, more specifically, to a WiMAX network and ensuring a PF address is provided for the SFA.

IPv6 (Internet Protocol Version 6) is the latest level of the Internet Protocol (IP) and is now included as part of IP support in many products including the major computer operating systems. IPv6 has also been called “IPng” (IP Next Generation). Formally, IPv6 is a set of specifications from the Internet Engineering Task Force (IETF). IPv6 was designed as an evolutionary set of improvements to the current IP Version 4. Network hosts and intermediate nodes with either IPv4 or IPv6 can handle packets formatted for either level of the Internet Protocol. Users and service providers can update to IPv6 independently without having to coordinate with each other.

Mobile IPv6 (MIPv) is a protocol developed as a subset of Internet Protocol version 6 (IPv6) to support mobile connections. MIPv6 is an update of the IETF (Internet Engineering Task Force) Mobile IP standard (RFC 2002) designed to authenticate mobile devices (known as mobile nodes) using IPv6 addresses.

The goal of the WiMAX Forum is to produce the standard for network architecture for networks based on the IEEE 802.16 wireless technology.

In reference to FIG. 1, the WiMAX network 100 includes a CSN (WiMAX Connectivity Serving Network) 102, which is comparable to a core network, and the ASN (WiMAX Access Serving Network) 104, which has the role of wireless access network. ASN and CSN could be operated by different business entities (operators).

The home CSN of a WiMAX subscriber contains the policy function (PF) 106, which holds the subscriber subscription information 108 and the corresponding QoS profiles. The PF is also responsible for authorizing the services for the subscriber. The QoS architecture in WiMAX networks is described in WiMAX NWG Stage 2, “WiMAX End-to-End Network System Architecture”, December 2005.

When a MS (WiMAX Mobile Station) attaches to the WiMAX network, the ASN performs authentication of the subscriber with the subscriber's home CSN. After the MS is successfully authenticated, the anchor SFA (Service Flow Authorization) function 112 registers itself with the PF in the CSN. At this point the PF will setup the pre-provisioned service flows by sending the appropriate commands to the anchor SFA.

After this time, the application function (AF), located in the CSN, can request a PF to setup an additional data flow with a particular QoS (Quality of Service) characteristic. For example, the SIP application server could request a separate service flow for a VoIP session. The PF will again send the appropriate commands to the anchor SFA function in the ASN.

The problem is that it is not at all clear how the anchor SFA function knows the address of the PF with which it should register.

The problem is further complicated by the fact that subscribers attaching to the ASN could belong to different NSPs (WiMAX Network Service Provider (operator of a CSN)). As a consequence, the anchor SFA function needs to register itself with different PFs located in different CSNs. This is rather inefficient and clumsy. Presently, the NWG stage 2 text does not specify any methods how the SFA function in the ASN comes into possession of the appropriate PF address.

The only conceivable method at the moment is that the WiMAX Access Network Provider (operator of an ASN) NAP operator manually configures the address of a PF into each anchor SFA. In case that the NAP supports multiple NSPs, anchor SFA must be manually preconfigured with one PF address per NSP. NSP can be identified via the domain part of a subscriber's NAI (Network Access Identifier), which is transmitted as part of subscriber authentication.

### SUMMARY

The inventor proposes for a PF address to be dynamically provided to the CSN.

Specifically, the inventor proposes a method for dynamically specifying a policy function (PF) used by a Service Flow Authorization (SFA) of an Internet Protocol (IP) network, comprising: a mobile station (MS) sends a request to a Network Access Server (NAS) (201), Service Equipment forwards the request to a Service Provider's AAA Server (202),—a connectivity serving network (CSN) sends an Access-Accept RADIUS message to an access serving network (ASN) (203), characterized in that, the method comprising the step of: inserting the PF address into the Access-Accept RADIUS message.

This is advantageous as the SFA anchor is provided the PF address with certainty.

The Access-Accept message may be formed in accordance with RFC2865 requirements.

The PF address may be inserted in binary form.

A PF-Identifier may be formed to contain a string representation of the PF address.

The method may involve authenticating the network using DIAMETER.

The inventor also proposes an Internet Protocol network that dynamically specifies a policy function (PF) used by a Service Flow Authorization (SFA) of an Internet Protocol (IP) network, comprising: a mobile station (MS) that sends a request to a Network Access Server (NAS) (201),—Service Equipment that forwards the request to a Service Provider's AAA Server (202), a connectivity serving network (CSN) that sends an Access-Accept RADIUS message to an access serving network (ASN) (203), characterized in that: a PF address is inserted into the Access-Accept RADIUS message.

The Access-Accept message may be formed in accordance with RFC2865 requirements.

The PF address may be inserted in binary form.

APF-Identifier containing a string representation of the PF address may be used.

The network may be a WiMAX network.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 illustrates a typical network of the related art, and

FIG. 2 illustrates a call flow employing the proposed method and network.

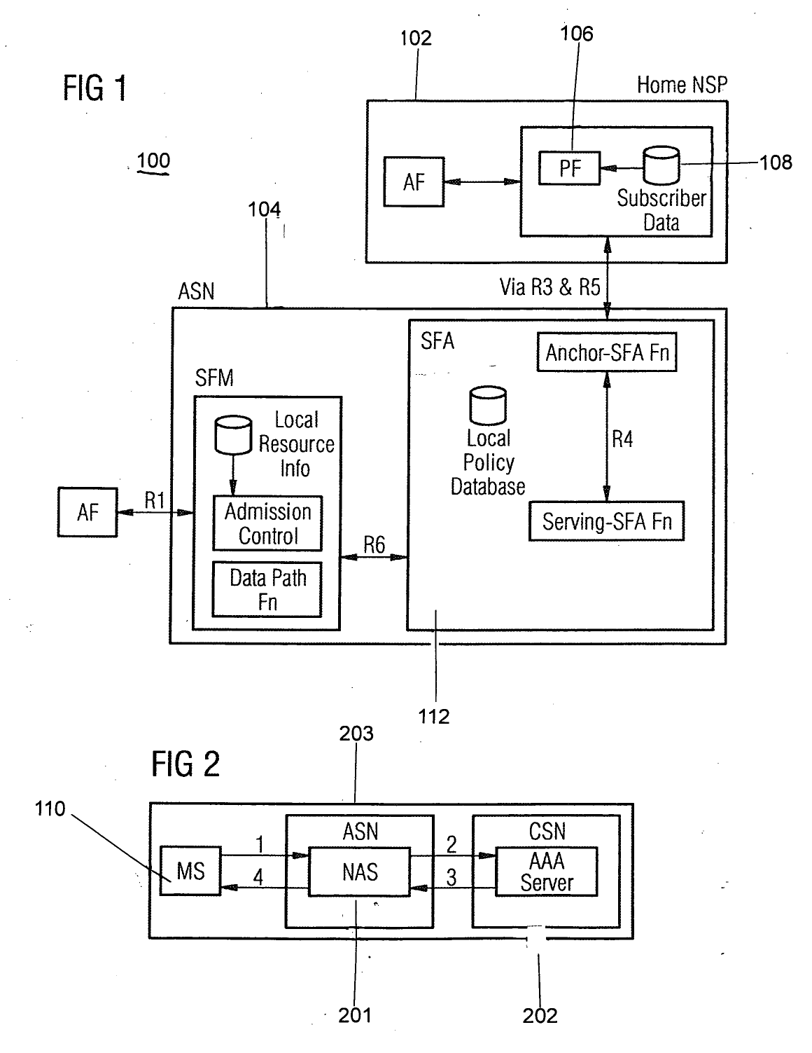

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

According to the proposed method, the CSN dynamically specifies the PF address to be used by the anchor SFA. Preferably, this dynamic assignment should be provided per user, thereby making it possible that different users belonging to the same NSP are assigned different PFs.

The proposal is to dynamically assign the PF address during the subscriber authentication. The subscriber authentication, as defined by NWG stage 2 text is shown in FIG. 2 that shows a Non-Roaming AAA (Authentication, Authorization and Accounting) Framework.

The user (e.g. MS) sends a request to the Service Equipment (e.g. Network Access Server-NAS) in step 201. The Service Equipment forwards the request in step 202 to the Service Provider's AAA Server. Service Provider's AAA server evaluates the request and returns an appropriate response to the Service Equipment.

Service Equipment provisions the bearer plane and notifies the user that it is ready.

The WiMAX networks use RADIUS as the authentication protocol between the ASN and the CSN. In case that the subscriber is successfully authenticated, the CSN will send the Access-Accept RADIUS message to the ASN in step 203.

In step 204 the MS is informed of the successful authentication (EAP is used for authentication, so EAP-Success message is sent to the MS in step 4). After successful authentication, the network provides the MS with the radio channel. The network allocates the necessary radio resources and informs the MS by sending the message DSC-Req (Dynamic Service Change Request).

The proposal is to define a new, vendor specific RADIUS attribute(s) which carries the address of a PF. This attribute(s) is included in Access-Accept RADIUS message. New vendor-specific RADIUS attribute are in line with the WiMAX Forum. This is made possible as the IETF has allocated an organization number to the WiMAX Forum, such that the WiMAX Forum can define its own vendor-specific attributes.

To introduce this new attribute into protocol specification, first there is provided an appropriate text in a form of WiMAX Forum contribution. Once the new attribute is defined in a protocol specification (as part of WiMAX Forum standard), the vendors will enhance their H-AAA servers with support for this new attribute such that it will be included in the Access Accept RADIUS message sent by AAA server.

The attribute of this proposal is defined along similar parameters as already existing parameters NAS-Address and NAS-Identifier, as defined in “RFC2865—Remote Authentication Dial In User Service (RADIUS), C. Rigney, et al., June 2000, Standards Track”. The proposed names for the new vendor-specific attributes of this proposal are: PF-Address and PF-Identifier.

PF-Address contains the IP address in binary form, and PF-Identifier contains the string representation of a PF address (for example, FQDN, Fully Qualified Domain Name).

It is probable that in the future also DIAMETER will be allowed as authentication protocol in WiMAX networks. The present proposal is also applicable to such networks. In that case, the same attributes are also defined for DIAMETER.

In case of manual configuration, the NAP operator will have to manually configure the PF address into every anchor SFA. If the NAP operator has business agreements with multiple NSPs, it will need to perform this manual configuration for every NSP. In case of dynamic PF assignment as in the present proposal, the manual configuration is not needed at all, thus saving the administrative effort. Manual configuration performed by a human operator is error prone. If SFA is configured with an invalid PF address, the result is that subscribers will not be able to use any WiMAX services whatsoever. Dynamic assignment, as described here for the first time, avoids the possibility for such error.

Further, the solution with manual configuration of a PF address in every anchor SFA does not scale well. Since anchor SFA maintains only single PF address per NSP, all subscribers of this NSP will use the same PF. This may bring the PF into overload. In the proposed solution, the NSP can dynamically assign different PFs to different subscribers, thus dividing the load among multiple PFs.

In case of manual configuration of PF address, the maintenance and upgrade of PF is complicated. When the NSP decides to change the address of a PF (because of fail-over scenario, or introduction of software upgrade, or a new hardware box), the NSP operator will have to update all anchor SFAs with the new address. This update must be performed manually (which opens room for human mistakes). Further, an NSP can have multiple associated NAPs (ASN sharing scenario), which means that the PF address will need to be updated in multiple access networks. Since in a WiMAX network the NSP and NAP are different business entities, this will result in complicated procedures between different administrative boundaries. A single NAP can have several dozens (or even several hundreds) of anchor SFAs, and an NSP can have ASN sharing agreements with dozens of NAPs. Thus the total number of SFAs to be updated when the PF address is changed can easily exceed couple of hundreds, which directly translates to a large effort in maintenance. In case of dynamic PD assignment, this dependency between operators doesn't exist.

The proposed introduction of additional, vendor-specific RADIUS attributes is completely in line with the current NWG stage 2 text. For example, the current text introduces already the Home Agent Address (HA@) and Dynamic Host Configuration Protocol (DHCP) Server Address (DHCP@) as new, vendor-specific RADIUS attributes which are used in Access-Accept message.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method for dynamically specifying a policy function (PF) used by a Service Flow Authorization of an Internet Protocol network, comprising:
sending a request from a mobile station to a Network Access Server in an access serving network;
forwarding the request from the Network Access Server to a Service Provider's Authentication Authorization Accounting (AAA) Server in a connectivity serving network;
inserting the PF address into an Access-Accept Remote Authentication Dial In User Service (RADIUS) message; and
sending the Access-Accept RADIUS message with the PF address inserted therein, from the connectivity serving network to the access serving network.

12. The method of claim 11, further comprising forming the Access-Accept RADIUS message in accordance with RFC2865 requirements.

13. The method of claim 11, wherein the PF address is inserted in binary form.

14. The method of claim 11, wherein the PF address is inserted by a method comprising:
forming a PF-Identifier containing a string representation of the PF address; and
inserting the PF-identifier into the Access-Accept RADIUS message.

15. The method of claim 11, further comprising authenticating the access serving network using a DIAMETER protocol.

16. The method of claim 12, wherein the PF address is inserted in binary form.

17. The method of claim 16, wherein the PF address is inserted by a method comprising:
forming a PF-Identifier containing a string representation of the PF address; and
inserting the PF-identifier into the Access-Accept RADIUS message.

18. The method of claim 17, further comprising authenticating the access serving network using a DIAMETER protocol.

19. An Internet Protocol network that dynamically specifies a policy function used for Service Flow Authorization, comprising:
an access serving network having a Network Access Server;
a mobile station that sends a request to the Network Access Server;
a connectivity serving network of a Service Provider, the connectivity serving network having an Authentication Authorization Accounting (AAA) Server;
Service Equipment provided in the access serving network that forwards the request to the AAA Server;
an insertion unit provided the connectivity serving network that inserts a policy function (PF) address into an Access-Accept Remote Authentication Dial In User Service (RADIUS) message; and
a transmission unit that sends the Access-Accept RADIUS message with the PF address inserted therein, from the connectivity serving network to the access serving network.

20. The network of claim 19, wherein the Access-Accept RADIUS message is formed in accordance with RFC2865 requirements.

21. The network of claim 19, wherein the PF address is inserted in binary form.

22. The network of claim 19, wherein
a PF-Identifier contains a string representation of the PF address, and
the PF-Identifier is inserted into the Access-Accept RADIUS message to insert the PF-address.

23. The network of claim 19, wherein the network is configured as a WiMAX network.

24. The network of claim 20, wherein the PF address is inserted in binary form.

25. The network of claim 24, wherein
a PF-Identifier contains a string representation of the PF address, and
the PF-Identifier is inserted into the Access-Accept RADIUS message to insert the PF-address.

26. The network of claim 25, wherein the network is configured as a WiMAX network.
